(19) United States
(12) Patent Application Publication
(10) Pub. No.: US 2019/0232519 A1
(43) Pub. Date: Aug. 1, 2019

(54) Heated Wire Cutting Tool

(71) Applicant: Kevin Matthews, Honolulu, HI (US)

(72) Inventor: Kevin Matthews, Honolulu, HI (US)

(21) Appl. No.: 16/263,597

(22) Filed: Jan. 31, 2019

Related U.S. Application Data
(60) Provisional application No. 62/624,900, filed on Feb. 1, 2018.

(51) Int. Cl. B26F 3/12; B26B 27/00

(52) U.S. Cl. CPC B26F 3/12; B26B 27/002

(57) ABSTRACT

A heated wire cutting tool designed to cut desserts without making a mess. The heated wire cutting tool is a formless cutting wire, having a heating element operably connected to the wire designed to heat the wire. A power source is operably connected to the heating element and designed to provide power to the heating element. A switch is operably connected to the power source and designed to activate the power source and thereby activate the heating element. Insulated handles are on the formless cutting wire, thus allowing the user to hold the formless cutting wire. In this way, a user is able to cut a dessert, such as a frozen cake, without creating a mess.

### CROSS REFERENCE TO RELATED APPLICATIONS

This application claims the benefit of U.S. Provisional Application No. 62/624,900 filed on Feb. 1, 2018. The above identified patent application is herein incorporated by reference in its entirety to provide continuity of disclosure.

### BACKGROUND OF THE INVENTION

The present invention relates to heated cutting tools. More specifically, the invention provides a formless cutting wire connected to a heating element configured to heat the wire.

Many people enjoy ordering and eating frozen desserts, such as an ice cream cake. However, these desserts are often difficult to cut properly, as cutting into them will often ruin the decoration of the dessert as the user struggles with forcing the knife through the dessert. Additionally, a knife can slip while attempting to cut through the frozen surface of the dessert and potentially injure the user. Although some users will leave the frozen dessert out to thaw, this can be time consuming and may lead to a ruined and melted cake if the user forgets the dessert is out. Thus, an improved cutting tool that can cut through desserts easily is desired.

### SUMMARY OF THE INVENTION

In view of the foregoing disadvantages inherent in the known types of cutting tools now present in the known art, the present invention provides a heated wire cutting tool wherein the same can be utilized for providing convenience for the user when desiring to efficiently cut a cake or frozen dessert.

The present system comprises a formless cutting wire, wherein a heating element operably connected to the wire is configured to heat the wire. A power source is operably connected to the heating element and configured to provide power to the heating element. A switch is operably connected to the power source and configured to actuate the power source and thereby actuate the heating element. Insulated handles are disposed on the formless cutting wire, thus allowing the user to hold the formless cutting wire. In this way, a user is able to cut a dessert, such as a frozen cake, without creating a mess.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the heated wire cutting tool.

FIG. 2 shows a close-up view of an embodiment of the exposed wire of the heated wire

FIG. 3 shows a close-up view of an embodiment of the handles of the heated wire cutting tool.

FIG. 4 shows a perspective view of an embodiment of the heated wire cutting tool in use.

### DETAILED DESCRIPTION OF THE INVENTION

Reference is made herein to the attached drawings. Like reference numerals are used throughout the drawings to depict like or similar elements of the heated wire cutting tool. The figures are intended for representative purposes only and should not be considered to be limiting in any respect.

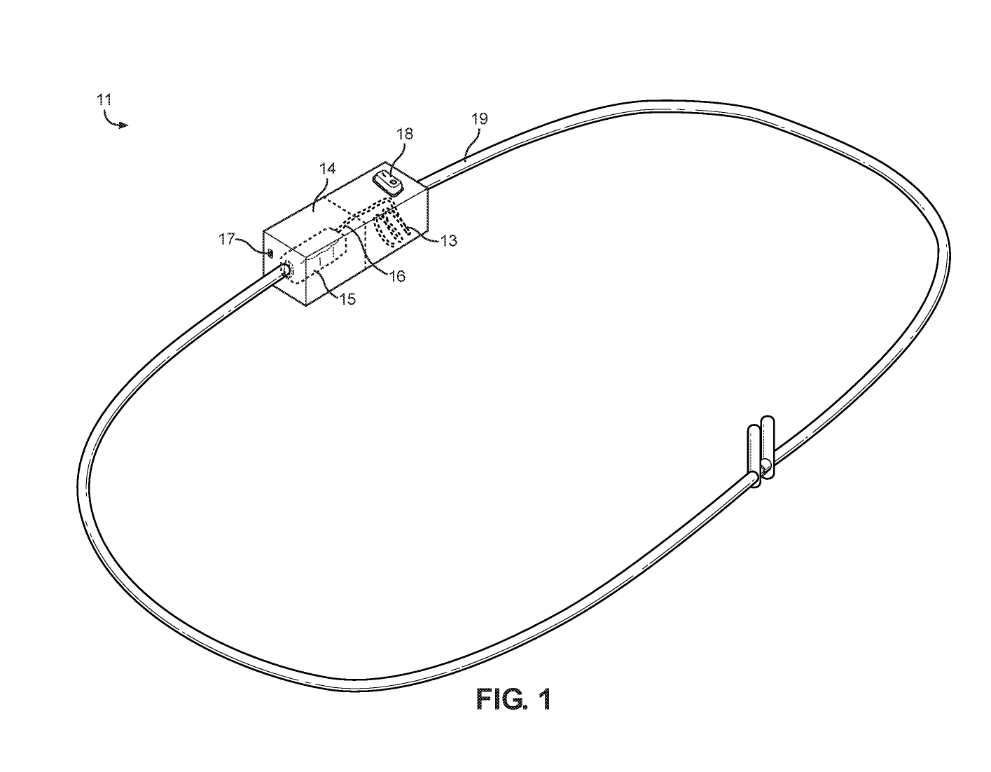

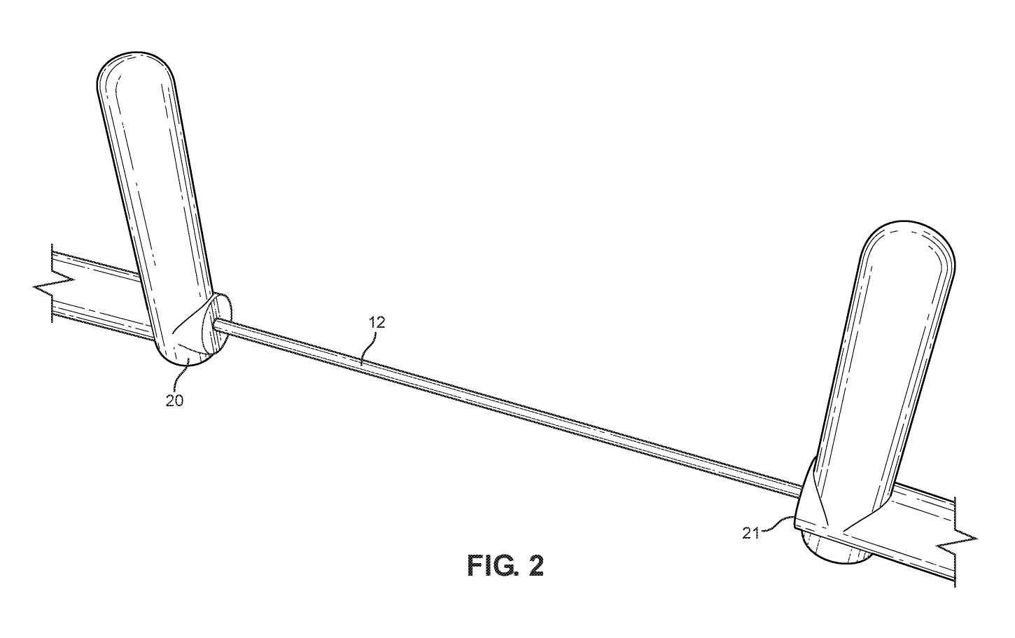

Referring now to FIG. 1 and FIG. 2, there is shown a perspective view of an embodiment of the heated wire cutting tool and a close-up view of an embodiment of the exposed wire, respectively. A heated wire cutting tool 11 comprises a formless cutting wire 12 having a heating element 13 operably connected to the wire 12, wherein the heating element 13 is configured to heat the wire 12. In the illustrated embodiment, the heating element 13 is disposed within a housing 14, wherein the heating element 13 comprises an induction coil operably connected to a power source 15, such as a rechargeable battery. In the illustrated embodiment, the power source 15 is disposed within the housing 14, and insulated from the heating element 13, such that when the heating element 13 produces heat, the heat does not damage the power source 15. Furthermore, in the illustrated embodiment, the power source 15 is operably connected to the heating element 13 through an insulated connection wire 16. In the illustrated embodiment, a charging port 17 is further disposed on the housing 14, wherein the charging port 17 is operably connected to the power source 15, thereby allowing a user to recharge the power source 15 through a charging cable. In the illustrated embodiment, the charging port 17 is disposed on a sidewall of the housing 14, however in other embodiments the charging port 17 can be disposed elsewhere on the housing 14, such as on the upper surface of the housing or on the lower surface of the housing.

In the illustrated embodiment, the heating element 13 is an induction coil, however in other embodiments, the heating element 13 comprises a battery or other suitable heating element configured to provide energy and generate heat along the wire 12. In the shown embodiment, the housing 14 is rectangularly shaped such that the lower surface of the housing 14 rests flush on a surface to provide support to the device and prevent it from rolling away. However, in other embodiments the housing 14 comprises any suitable stable shape, such as a cylinder, should the user find a different shape more aesthetically please or easier to grip.

A switch 18 is disposed on the housing 14, wherein the switch 18 is configured to actuate the heating element 13 when used. In the illustrated embodiment, the switch 18 comprises a binary switch, such as a toggle switch or a rocker switch, wherein the switch 18 can be toggled to an “on-off” position, per the user's input. In another embodiment, the switch 18 comprises a variable component, such that the user can control the amount to which heating element 13 heats the wire 12. In this way, the user can differentiate between two different items requiring two different levels of heat, such as a regular cake and a frozen ice cream cake.

In one embodiment, the heated wire cutting tool 11 further comprises an insulated sleeve 19, having a first end 20 and a second end 21, wherein the insulated sleeve 19 is disposed around the wire 12. In the illustrated embodiment, the insulated sleeve 19 is slidably disposed around the wire 12, such that a user can freely move the insulated sleeve 19 around the wire 12, thereby exposing a portion of the wire 12 for use. In one embodiment, the insulated sleeve 19 is composed of rubber, however any suitably durable insulating material can be used for the insulated sleeve 19. In the illustrated embodiment, the first end 20 and the second end 21 are biased towards one another such that the insulated sleeve 19 is fully disposed around the wire 12 with the first end 20 and the second end 21 flush against one another. Thus, no portion of the wire 12 is exposed until the user slidably compresses the insulated sleeve 19 to expose the wire 12, whereas the force from the compressed insulated sleeve 19 pushes the first end 20 and second end 21 together when the insulated sleeve 19 is released. In a further embodiment, a fastener is disposed on the first end 20 with a mating fastener disposed on the second end 21, such as a pair of magnets, to prevent the insulated sleeve 19 from shifting until the user desires to expose the wire 12.

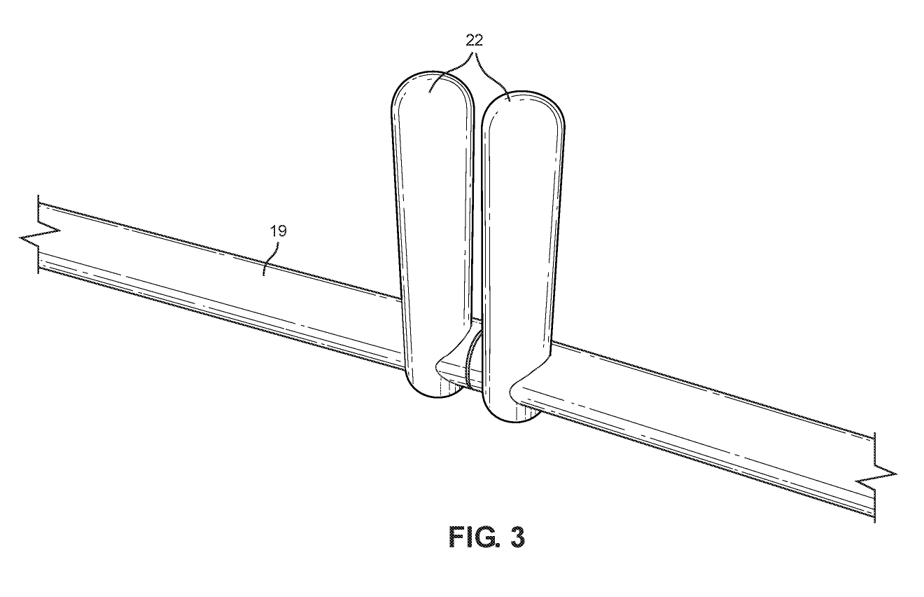

Referring to FIG. 3, there is shown a close-up view of an embodiment of the handles of the heated wire cutting tool. The heated wire cutting tool further comprises a pair of handles 22 disposed on the wire. In the illustrated embodiment, the handles 22 are disposed on the insulated sleeve 19 itself and composed of a material similar to the material used for the insulated sleeve 19 such that the handles 22 are also insulated. In one embodiment, the handles 22 are disposed perpendicular to the insulated sleeve 19, such that the user can grasp the handles 22 without touching the insulated sleeve 19, thereby giving them additional space and insulation from the wire when heated and providing a greater degree of safety to the user.

The handles 22 are configured to be appropriately sized to the desired user, and as such have a smaller size and a larger size, depending on the size of the user's hands. In an alternate embodiment, the handles 22 are sized such that each handle 22 is configured to be pinched between the thumb and index finger, as opposed to gripped with a hand. However, in another embodiment, the handles 22 further comprise an ergonomic grip having a series of grooves and ridges, wherein the grooves and ridges are configured to align with the fingers and hand of the user to provide a secure gripping surface, and the handles 22 are large enough for a hand to wrap around each handle. In the illustrated embodiment, each handle 22 is disposed at each end of the insulated sleeve 19, such that the handles 22 are configured to sit flush against one another when the wire is not exposed.

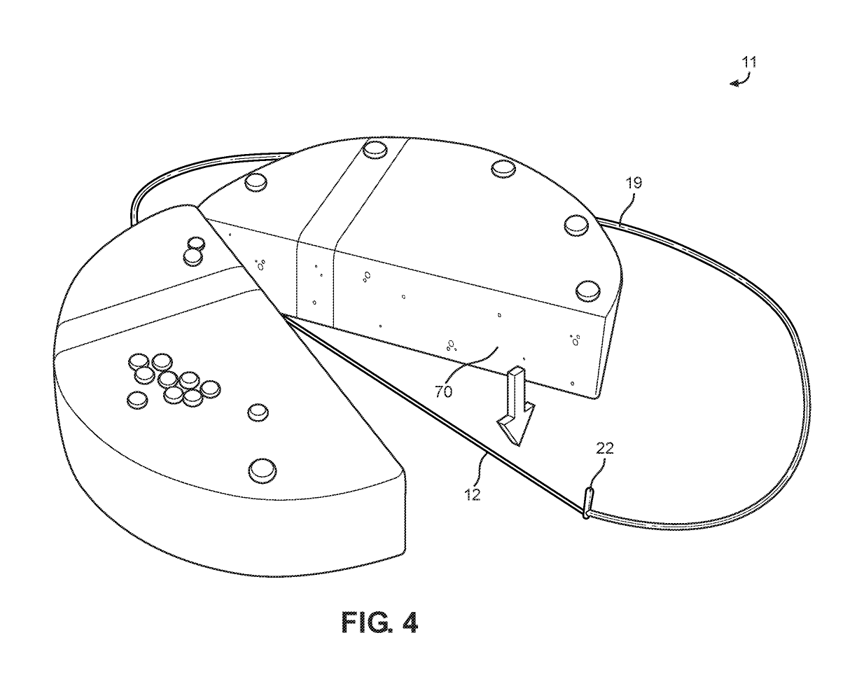

Referring to FIG. 4, there is shown a perspective view of an embodiment of the heated wire cutting tool in use. In operation, a user will utilize the switch disposed on the housing of the heating element of the heated wire cutting tool 11 to actuate the heating element, providing a heat to the wire 12. The user will then pinch or grip the handles 22 in either hand, and pull the handles 22 apart, thereby sliding the insulated sleeve 19 to expose the now heated wire 12. The user is then able to push the heated wire 12 through the dessert 70, such as a frozen cake, thereby easily cutting the dessert 70 without creating a mess.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A heated wire cutting tool, comprising:
a cutting wire;
a heating element configured to heat the wire;
a power source operably connected to the heating element and configured to power the heating element;
a switch operably connected to the power source;
insulated handles disposed on the formless cutting wire.

2) The heated wire cutting tool of claim 1, further comprising:
an insulated sleeve, having a first end and a second end, slidably disposed around the formless cutting wire;
wherein the insulated sleeve is selectively movable between a first position and a second position, wherein the cutting wire is exposed when in the first position.

3) The heated wire cutting tool of claim 2, wherein the handles are disposed on either end of the insulated sleeve.

4) The heated wire cutting tool of claim 2, wherein the first end and the second end are configured to sit flush against one another when in the second position.

5) The heated wire cutting tool of claim 1, wherein the handles are disposed perpendicular to the wire.

6) The heated wire cutting tool of claim 1, wherein the heating source and power source are both disposed within a housing.

7) The heated wire cutting tool of claim 6, wherein the power source is separated from the heating source in an insulated portion of the housing.

8) The heated wire cutting tool of claim 6, wherein a charging port is disposed on the housing, wherein the charging port is operably connected to the power source.

9) The heated wire cutting tool of claim 1, wherein the switch comprises a variable component, such that the user can adjust the amount of heat in the wire.

10) The heated wire cutting tool of claim 1, wherein the first end and the second end of the insulated wire are biased towards one another to create a closed position.
